(19) United States
(12) Patent Application Publication
(10) Pub. No.: US 2008/0230973 A1
(43) Pub. Date: Sep. 25, 2008

(54) POSITIONING AND CLAMPING APPARATUS

(75) Inventor: Satoshi Miyazaki, Tokyo (JP)

Correspondence Address: MCCORMICK, PAULDING & HUBER LLP, CITY PLACE II, 185 ASYLUM STREET, HARTFORD, CT, 06103, US

(73) Assignee: Koganei Corporation, Tokyo (JP)

(21) Appl. No.: 12/049,442

(22) Filed: Mar. 17, 2008

(30) Foreign Application Priority Data
Mar. 20, 2007 (JP) 2007-73235

(51) Int. Cl. B23Q 3/00

(52) U.S. Cl. 269/309

(57) ABSTRACT

A positioning and clamping apparatus, capable of positioning and clamping of a panel material and removing the panel material from a locating pin by releasing the clamping, is provided. A support cylinder, having a contact face with which the panel material contacts, is provided with a locating pin that protrudes from the contact face. An opening/closing piston is received reciprocably into a cylinder body linked to the support cylinder. A piston rod is linked to a clamp arm provided in a slit of the locating pin. When the opening/closing piston moves forward, the clamp arm moves to an escaping position. When the opening/closing piston moves backward, the clamp arm reaches a clamping position where the panel material is clamped between the clamp portion and the contact face. The panel material is driven at a removal position where it is removed from the locating pin by a pusher.

### CROSS-REFERENCE TO RELATED APPLICATIONS

Applicant hereby claims foreign priority benefits under U.S.C. §119 from Japanese Patent Application No. JP 2007-73235 filed on Mar. 20, 2007, the contents of which are incorporated by reference herein.

### TECHNICAL FIELD OF THE INVENTION

The present invention relates to a positioning and clamping apparatus capable of positioning and clamping a panel material with a locating pin as well as removing the panel material from the locating pin.

### BACKGROUND OF THE INVENTION

An automobile body is formed by joining a plurality of panel materials to each other by spot welding. In carrying out the spot welding, it is necessary to position and clamp various kinds of panel materials, which constitute the automobile body. Therefore, in order to position and clamp these panel materials, a plurality of positioning and clamping apparatuses are attached to a welding stage located in an automobile production line. Also, by mounting the positioning and clamping apparatus on a tip of a robot arm and operating and moving the robot arm, the positioning and clamping apparatus positions and clamps the panel materials. Further, on a carrier truck for carrying the panel materials, a plurality of positioning and clamping apparatuses are mounted for clamping the panel materials.

In any cases, the conventional positioning and clamping apparatus has the locating pin which is fitted to a positioning hole formed in the panel material that is a workpiece. By fitting the locating pin to the positioning hole, the panel material is positioned. Furthermore, in order to clamp the panel material, a clamp arm is incorporated into a slit formed in the locating pin so that the clamp arm can come out from the slit in clamping the panel material. This type of positioning and clamping apparatus is disclosed in, for example, Japanese Patent Application Laid-Open Publication No. 2000-176874 (Patent Document 1) and Japanese Patent Application Laid-Open Publication No. 2003-260626 (Patent Document 2).

### SPRY OF THE INVENTION

If such a conventional positioning and clamping apparatus is provided to the welding stage, the spot welding is carried out while the clamp arm positions and clamps the panel material. After completion of the welding, the panel material is removed from the locating pin while the clamp arm is released. In order to remove the panel material, a panel removal device is disposed adjacently to the positioning and clamping apparatus. However, if the panel removal device and the positioning and clamping apparatus are provided to the welding stage or the tip of the robot arm, areas occupied by these device and apparatus are increased.

An object of the present invention is to provide a positioning and clamping apparatus capable of positioning and clamping a panel material and, while the clamping is released, removing the panel material from a locating pin.

A positioning and clamping apparatus according to the present invention comprises: a support cylinder provided with a contact face, with which a panel material contacts, and provided with a locating pin protruding from the contact face and penetrating through a through-hole formed in the panel material; a cylinder body linked to the support cylinder, and receiving axially reciprocably an opening/closing piston provided with a piston rod; a clamp arm provided in a slit formed in the locating pin, and linked swingably to the piston rod; a cam member penetrating through a cam hole formed in the clamp arm to be fixed to the support cylinder, the cam member causing the clamp arm to move, due to forward movement of the opening/closing piston, at an escaping position where the clamp arm is escaped into the slit, and causing the clamp arm to come out, due to retreat movement of the opening/closing piston, at a clamping position where the panel material is clamped between a clamp portion and the contact face; a pusher protruding from the contact face, and mounted axially reciprocably in the support cylinder between a removal position where the panel material is removed from the locating pin and a retreat limit position where the pusher enters into the contact face; and a pushing piston linked to the pusher and received reciprocably in the cylinder body, and driving the pusher between the removal position and the retreat limit position.

The positioning and clamping apparatus according to the present invention further comprises: a spring member causing the pusher to come out at a waiting position which is between the removal position and the retreat limit position; and a position detecting sensor for detecting a position of the pushing piston, wherein the position detecting sensor detects that the panel material causes the pusher to move backward against a spring force of the spring member and contacts with the contact face.

The positioning and clamping apparatus according to the present invention further comprises: a forward pressurizing chamber for supplying fluid which applies a forward-directional thrust force to the pushing piston; and a retreat pressurizing chamber for supplying fluid which applies a retreat-directional thrust force to the pushing piston, wherein the forward pressurizing chamber and the retreat pressurizing chamber are formed in the cylinder body.

The positioning and clamping apparatus according to the present invention further comprises: a clamp pressurizing chamber for applying a retreat-directional thrust force to the opening/closing piston; and an escaping operation chamber for applying a forward-directional thrust force to the opening/closing piston, wherein the clamp pressurizing chamber and the escaping operation chamber are formed in the cylinder body.

The positioning and clamping apparatus according to the present invention is such that a spring member for applying the forward-directional thrust force to the opening/closing piston is mounted into the escaping operation chamber.

The positioning and clamping apparatus according to the present invention is such that fluid for applying a forward-directional thrust force to the opening/closing piston is supplied into the escaping operation chamber.

The positioning and clamping apparatus according to the present invention is such that a locking piston, contacting with a locking face formed in the piston rod, is received in a lock cylinder provided to the cylinder body so as to be horizontally reciprocable with respect to the piston rod, a spring member for applying, to the locking piston, a thrust force orientated to the piston rod, is incorporated into the locking cylinder, and the clamp arm is held at the clamping position by contacting the locking piston and the locking face to each other.

According to the present invention, the panel material is positioned at a predetermined position by the locating pin that penetrates through the through-hole formed in the panel material, and then is clamped by the clamp arm provided to the locating pin while being positioned. Thus, a welding operation is performed to the panel material while the panel material is clamped. After the operation is completely performed to the panel material, the clamping of the panel material by the clamp arm is released, and then the panel material is automatically removed from the locating pin by activating the pusher. Therefore, the panel material as a workpiece can be easily taken out from the positioning and clamping apparatus.

Since the pusher is provided to the support cylinder along with the clamp arm, it becomes unnecessary to dispose, near the positioning and clamping apparatus, any device for removing the panel material from the positioning and clamping apparatus and it is possible to remove the panel material by a small apparatus after the operation is completed.

Since the position of the pushing piston for driving the pusher is detected by the position detecting sensor, a state where the panel material is removed by the pusher can be detected. Accordingly, it becomes unnecessary to provide any position detecting sensor near the clamp arm or near a moving trajectory of the panel material.

Both of the opening/closing piston that is driven to open/close the clamp arm and the pushing piston that drives the pusher are provided to the cylinder body linked to the support cylinder, so that a width dimension of the positioning and clamping apparatus can be downsized.

When the piston rod driven by the opening/closing piston reaches the clamping position, the locking piston fastens the piston rod. Since a fastening force is applied by a spring member, it becomes unnecessary to apply the fluid in a state where the clamp arm is at the clamping position, whereby the clamp arm can be held at the clamping position.

### BRIEF DESCRIPTION OF THE DRAWINGS

FIG. 1 is a sectional view showing a positioning and clamping apparatus according to an embodiment of the present invention;

FIG. 2 is a sectional view taken along line 2-2 in FIG. 1;

FIG. 3 is a plane view of FIG. 1;

FIG. 4A is a sectional view of a locating pin;

FIG. 4B is a plane view of FIG. 4A;

FIG. 4C is a bottom plan view of FIG. 4A;

FIG. 5A is a sectional view of a work-receiving ring;

FIG. 5B is a plane view of FIG. 5A;

FIG. 6A is a sectional view showing a pusher;

FIG. 6B is a plane view as viewed from a direction extending along line 6B-6B in FIG. 6A;

FIG. 6C is a sectional view taken along line 6C-6C in FIG. 6A;

FIG. 6D is a sectional view taken along line 6D-6D in FIG. 6A;

FIG. 7A is a schematic view showing an operation state of the positioning and clamping apparatus; and

FIG. 7B is a schematic view showing an operation state of the positioning and clamping apparatus.

### DESCRIPTION OF THE PREFERRED EMBODIMENTS

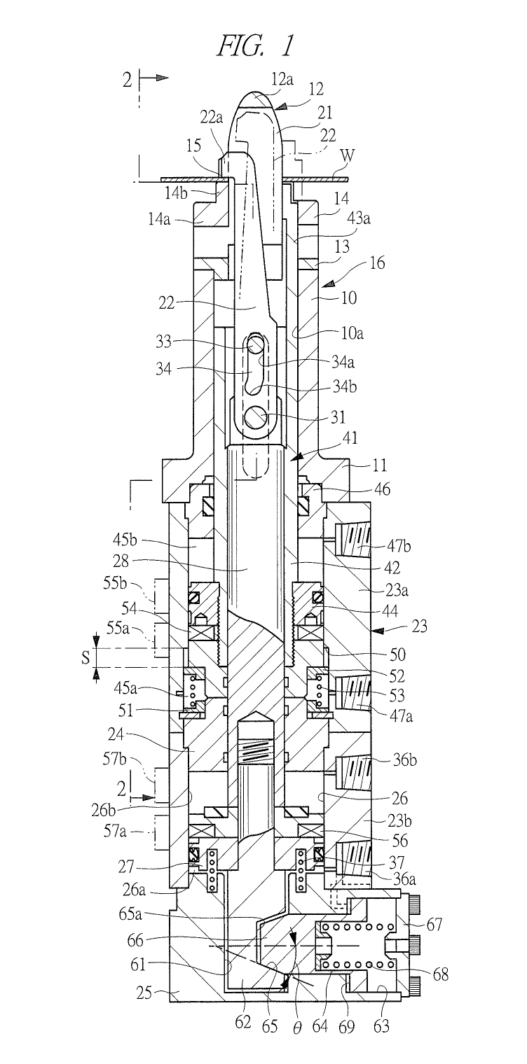

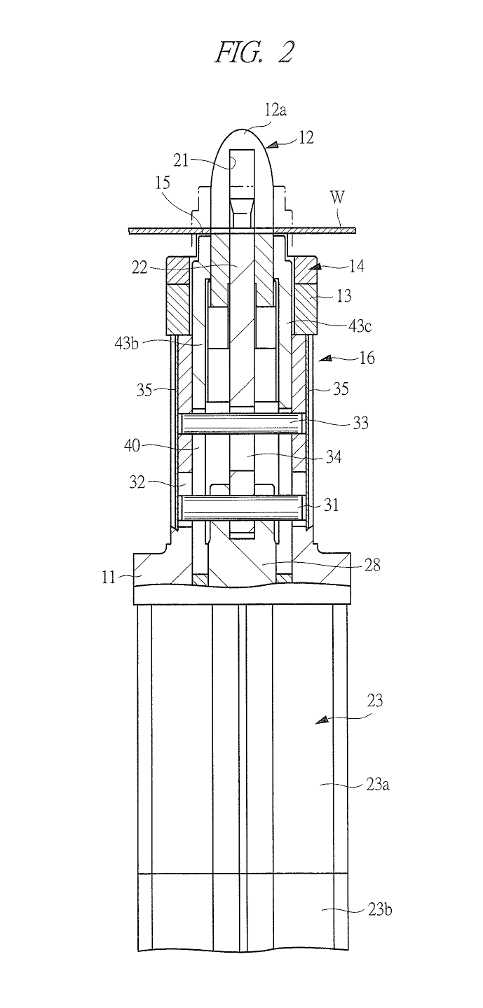

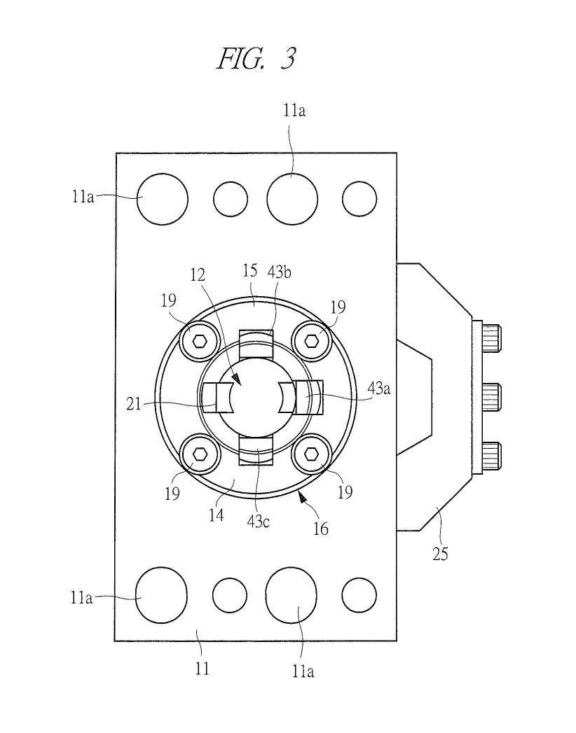

Hereinafter, an embodiment of the present invention will be described in detail with reference to the drawings. FIG. 1 is a sectional view showing a positioning and clamping apparatus according to an embodiment of the present invention; FIG. 2 is an enlarged sectional view taken along line 2-2 in FIG. 1; and FIG. 3 is a plane view of FIG. 1.

A positioning and clamping apparatus is disposed on, for example, a welding stage in an automobile production line and is used for positioning and clamping various kinds of panel materials constituting an automobile body. The positioning and clamping apparatus includes a cylindrical body 10, and a distal portion of the cylindrical body 10 is, as shown in FIG. 3, provided with a rectangular flange portion 11. A plurality of attaching holes 11a are formed in the flange portion 11, and the cylindrical body 10 is attached to the welding stage by screw members or pins mounted into the respective attaching holes 11a.

A circular receiving hole 10a is formed in the cylindrical body 10, a locating pin 12 is attached to a tip of the cylindrical body 10, and a distal portion side of the locating pin 12 is provided integrally with a flange portion 13. The locating pin 12 is fixed to a tip of the cylindrical body 10 by a work-receiving ring 14 that contacts with the flange portion 13. The work-receiving ring 14 comprises a large diameter portion 14a located on its distal side and a small diameter portion 14b integrally formed therewith and located on a tip side of the work-receiving ring. A contact face 15 is formed at a tip face of the small diameter portion 14b. Incidentally, the work-receiving ring 14 may be formed into such a ring shape that its outer diameter has wholly the same dimension as that of the large diameter portion 14a and that its outer circumferential surface becomes straight in a longitudinal direction. The cylindrical body 10 and the work-receiving ring 14 as described above constitute a support cylinder 16. A tip of the support cylinder 16 is the contact face 15 with which a panel material W contacts, and the locating pin 12 protrudes from the contact face 15. Therefore, as shown in FIG. 1, when the locating pin 12 is caused to penetrate through a through-hole formed in the panel material W, the panel material W is positioned at a predetermined position of the welding stage.

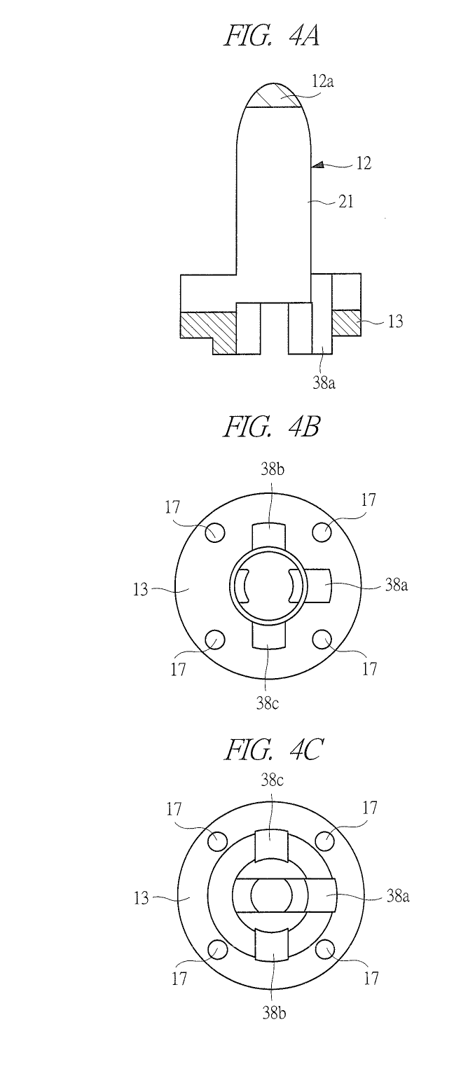

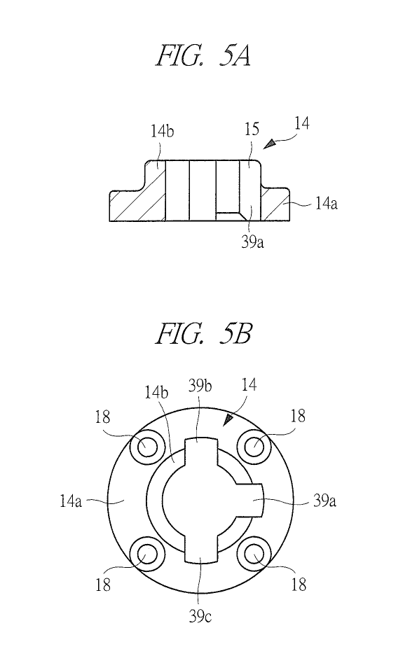

FIG. 4A is a sectional view of the locating pin 12; FIG. 4B is a plane view of FIG. 4A; and FIG. 4C is a bottom plan view of the locating pin 12 of FIG. 4A. FIG. 5A is a sectional view of the work-receiving ring 14; and FIG. 5B is a plane view of FIG. 5A.

Four through-holes 17 are formed in the flange portion 13 of the locating pin 12, and four spot-facing-equipped through-holes 18 are formed in the work-receiving ring 14 so as to correspond to the through-holes 17, respectively. As shown in FIG. 3, the locating pin 12 and the work-receiving ring 14 are fixed to the cylindrical body 10 by bolts 19 that are screwed into screw holes (not shown) formed in the cylindrical body 10 through the respective through holes 17 and 18.

A slit 21 is formed in the locating pin 12 by leaving its tip 12a. The slit 21 extends up to a distal face of the flange portion 13 and penetrates through the locating pin 12 in its diameter direction. As shown in FIG. 1, a clamp arm 22 is incorporated into the slit 21.

A cylinder body 23 is attached to the flange portion 11 of the support cylinder 16 so as to be coaxial with the support cylinder 16. The cylinder body 23 includes a first cylinder 23a and a second cylinder 23b, wherein a partitioning wall 24 is fixed to the cylinder body 23 so as to cross both of abutting end portions of the cylinders 23a and 23b. A block-shaped lock cylinder 25 functioning as a cover for blocking the cylinder body 23 is fixed to a rear end portion of the cylinder body 23. In a cylinder hole 26 inside the cylinder body 23, an opening/closing piston 27 is mounted axially reciprocably between the partitioning wall 24 and the lock cylinder 25. An escaping operation chamber 26a and a clamp pressurizing chamber 26b are formed in the cylinder hole 26 by the opening/closing piston 27. A piston rod 28 is attached to the opening/closing piston 27, and the tip portion of the piston rod 28 is inserted into an interior of the cylindrical body 10 through the partitioning wall 24.

The clamp arm 22 is pin-connected to the tip portion of the piston rod 28 by a linking pin 31 oriented to a diameter direction with respect to the piston rod 28, whereby the clamp arm 22 is swingably linked to the piston rod 28. As shown in FIG. 2, both end portions of the linking pin 31 enter into long holes 32 formed in the support cylinder 16, so that when the piston rod 28 is reciprocated axially by the opening/closing piston 27, the linking pin 31 is guided by the long holes 32 to move axially.

To the support cylinder 16, a cam member 33 formed of a round bar is fixed so as to be oriented to a diameter direction with respect to the support cylinder 16 and be parallel to the linking pin 31. The cam member 33 penetrates through a cam hole 34 formed in the clamp arm 22. The cam hole 34 includes: a vertical portion 34a extending in a longitudinal direction of the clamp arm 22 from a tip side of the clamp arm 22 toward the distal portion thereof; and an escaping portion 34b continuing to the vertical portion 34a and inclined to the vertical portion 34a. By such a structure, as shown in FIG. 1, when the opening/closing piston 27 reaches the retreat limit position, the clamp arm 22 is driven up to the clamping position via the piston rod 28 and simultaneously a top clamp portion 22a is, by the cam member 33, at the clamping position where the panel material W is cramped between the contact face 15 and the clamp portion 22a. Meanwhile, when the opening/closing piston 27 reaches its forward limit position, the clamp arm 22 reaches, via the piston rod 28, an escaping position where the clamp arm 22 enters into an interior of the slit 21 as shown by the double-dot line in FIG. 1. Both end faces of the linking pin 31 and the cam member 33 are, as shown in FIG. 2, covered with a cover plate 35 attached to the support cylinder 16.

In the cylinder body 23 are formed a supply/discharge port 36a that communicates with the escaping operation chamber 26a and a supply/discharge port 36b that communicates with the clamp pressurizing chamber 26b. When compressed air as fluid is supplied into the escaping operation chamber 26a from the supply/discharge port 36a, the clamp arm 22 is driven to the escaping position via the opening/closing piston 27 and the piston rod 28. Meanwhile, when the fluid is supplied into the clamp pressurizing chamber 26b from the supply/discharge port 36b, the clamp arm 22 is driven to the clamping position via the opening/closing piston 27 and the piston rod 28. In order to apply a forward-directional thrust force to the opening/closing piston 27 in addition to pressure of the fluid, a helical compression spring 37 as a spring member is mounted into the escaping operation chamber 26a. Incidentally, if the fluid is intended not to be supplied to the escaping operation chamber 26a, the forward-directional thrust force is applied to the opening/closing piston 27 only by the helical compression spring 37. Therefore, if the helical compression spring 37 is not mounted, the forward-directional thrust force is applied to the opening/closing piston 27 only by pressure of the fluid.

As shown in FIGS. 4A to 4C, three guide grooves 38a to 38c are formed in the flange portion 13 of the locating pin 12 so as to be located outwardly in the diameter direction of the locating pin 12, wherein the guide groove 38a is formed on an opposite side to a position where the clamp portion 22a of the clamp arm 22 comes out, and wherein the other two guide grooves 38b and 38c are formed at positions where each of them is displaced an angle of 90° in a circumferential direction so as to be centered about the guide groove 38a. As shown in FIG. 5, guide grooves 39a to 39c are formed in the large diameter portion 14a of the work-receiving ring 14 so as to correspond to the guide grooves 38a to 38c, respectively.

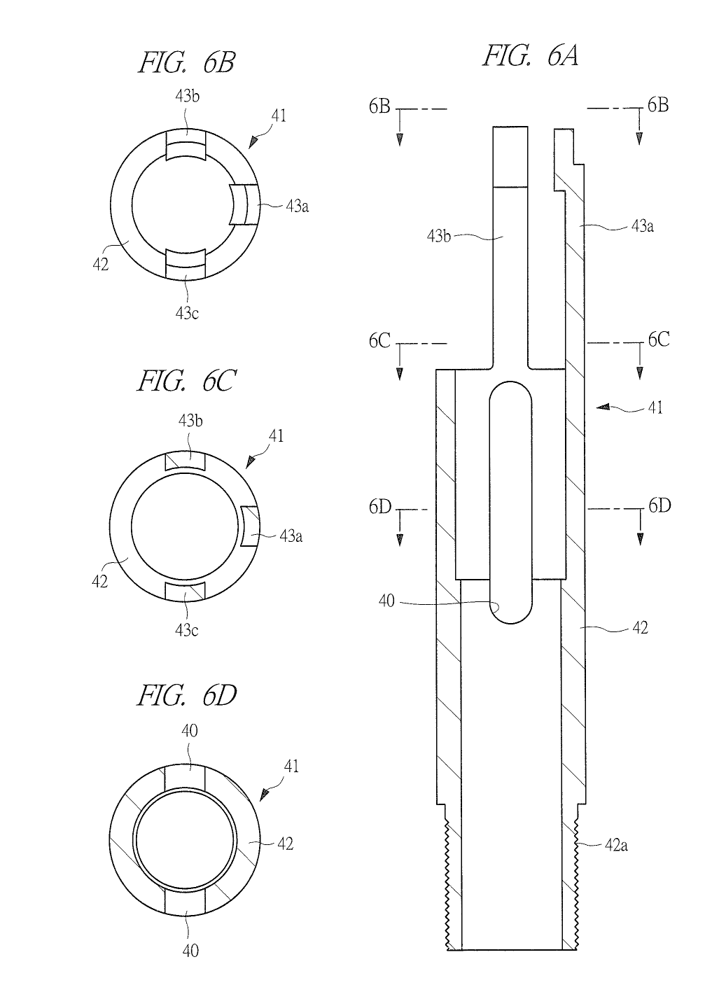

A pusher 41 is incorporated axially reciprocably into the support cylinder 16. FIG. 6A is a sectional view showing the pusher 41; FIG. 6B is a plane view as viewed from a direction extending along line 6B-6B in FIG. 6A; FIG. 6C is a sectional view taken along line 6C-6C in FIG. 6A; and FIG. 6D is a sectional view taken along line 6D-6D in FIG. 6A.

As shown in FIG. 1, the pusher 41 includes a cylindrical portion 42 outside the piston rod 28, wherein the cylindrical portion 42 is fitted axially movably to the piston rod 28. In order to prevent the pusher 41 from interfering with the linking pin 31 and the cam member 33 in moving in the axial direction of the pusher 41, a long hole 40 is formed in the cylindrical portion 42. As shown in FIGS. 6A to 6D, the cylindrical portion 42 is provided with three pushing bar members 43a to 43c protruding forward from a tip face of the cylindrical portion 42, wherein each of the pushing bar members 43a to 43c is formed integrally with the cylindrical portion 42. The pushing bar member 43a enters into the guide grooves 38a and 39a which are formed in the flange portion 13 of the locating pin 12 and in the large diameter portion 14a of the work receiving ring 14, respectively. The pushing bar member 43b enters into the guide grooves 38b and 39b. The pushing bar member 43c enters into the guide grooves 38c and 39c. When the pusher 41 is reciprocated, each of the pushing bar members 43a to 43c moves along the locating pin 12. FIG. 1 shows a state where the pusher 41 is at the retreat limit position. At this time, each of the pushing bar members 43a to 43c enters into the support cylinder 16. Meanwhile, when the pusher 41 reaches the forward limit position, each of the pushing bar members 43a to 43c protrudes from the contact face 15 and reaches a removal position. When the pusher 41 is driven at the removal position, the panel material W is pushed out up to the tip portion of the locating pin 12 by the pushing bar members 43a to 43c.

Although the panel material W is pushed out up to the tip portion of the locating pin 12 by the pusher 41, if a moving stroke of the pusher 41 is set larger than that illustrated in Figures, the panel material W can be pushed out up to the tip portion of the locating pin 12.

In order for the pusher 41 to be driven between the retreat limit position and the removal position, a ring-shaped pushing piston 44 is fixed to the cylindrical portion 42 of the pusher 41. A mail screw 42a to be screwed with a female screw formed in an inner circumferential surface of the pushing piston 44 is formed, as shown in FIGS. 6A to 6D, in the cylindrical portion 42. In the cylinder hole 26 inside the cylinder body 23, a space between the pushing piston 44 and the partitioning wall 24 serves as a forward pressurizing chamber 45a, and a space between a rod cover 46 provided to the tip portion of the cylinder body 23 and the pushing piston 44 serves as a retreat pressurizing chamber 45b.

In the cylinder body 23 are formed a supply/discharge port 47a that communicates with the forward pressurizing chamber 45a and a supply/discharge port 47b that communicates with the retreat pressurizing chamber 45b. When fluid is supplied to the forward pressurizing chamber 45a from the supply/discharge port 47a, the pusher 41 is driven up to the forward limit position. Meanwhile, when the fluid is supplied to the retreat pressurizing chamber 45b from the supply/discharge port 47b, the pusher 41 is driven up to the retreat limit position.

A spring receiving seat 51 is attached to the partitioning wall 24. The pushing piston 44 is provided with a spring receiving seat 52 so as to oppose to the spring receiving seat 51 and to be reciprocable axially to the pushing piston 44 and the cylinder body 23. A movement limit position of the spring receiving seat 52 in its forward direction is restricted by a step portion 50 formed in an inner circumferential surface of the cylinder body 23. Between the spring receiving seats 51 and 52, a helical compression spring 53 as a spring member is mounted, whereby the forward-directional thrust force is applied to the pusher 41 by a spring force of the helical compression spring 53. Therefore, while the fluid is not supplied to any of the forward pressurizing chamber 45a and the retreat pressurizing chamber 45b, the pusher 43 is at a waiting position where each of tip portions of the pushing bar members 43a to 43c protrudes a predetermined stroke from the contact face 15 by the spring force of the compression spring 53. Such a stroke that each tip portion of the pushing bar members 43a to 43c protrudes from the contact face 15 to the waiting position corresponds to a stroke of the spring receiving seat 52 as indicated by the symbol “S” in FIG. 1. A protruding position of each tip face of the pushing bar members 43a to 43c at the waiting position is an intermediate position between the forward limit position and the retreat limit position. As shown in FIG. 1, when the pushing piston 44 of the pusher 41 reaches the retreat limit position, each tip face of the pushing bar members 43a to 43c becomes at a position where each tip face is retreated slightly from the contact face 15.

Under such a waiting state that each tip face of the pushing bar members 43a to 43c protrudes only the stroke “S” from the contact face 15, when the panel material W is set at the locating pin 12, the pushing bar members 43a to 43c are pressed by the panel material W and the pusher 41 moves backward from the waiting position to a position where the tip faces of the pushing bar members 43a to 43c coincide with the contact face 15. Under this state, when the piston rod 28 is driven up to the retreat limit position by the opening/closing piston 27, the clamp arm 22 becomes at the clamping position, whereby the top clamp portion 22a comes out and the panel material W is clamped, i.e., fastened by the clamp arm 22 and the contact face 15. In order to remove the panel material W from the locating pin 12, the clamp arm 22 is driven from the clamping position to the escaping position and then the pusher 41 is driven up to the forward limit position which is the removal position.

A magnet 54 is mounted in an annular groove formed in the pushing piston 44, and two position detecting sensors 55a and 55b sensitive to a magnetic force of the magnet 54 are attached to the cylinder body 23. By such a structure, when the pushing bar members 43a to 43c enter into the support cylinder 16, the position detecting sensor 55a is sensitive to the magnetic force of the magnet 54 and detects that the pushing piston 44 has been retreated up to the position shown in FIG. 1. Meanwhile, when the pushing piston 44 moves to the removal position, the position detecting sensor 55b is sensitive to the magnetic force of the magnet 54 and detects that the pushing piston 44 has been at the removal position.

According to the position of the pushing piston 44 which drives the pusher 41, each of the position detecting sensors 55a and 55b detects whether the panel material W is set at the contact face 15 or whether it is removed from the locating pin 12. Therefore, the pushing bar members 43a to 43c function as sensor dogs for activating the sensors, so that it becomes unnecessary to provide the position detecting sensors 55a and 55b near the clamp arm 22 or to the support cylinder 16.

A magnet 56 is mounted in an annular groove provided in the opening/closing piston 27, and two position detecting sensors 57a and 57b sensitive to a magnetic force of the magnet 56 are attached to the cylinder body 23 so as to correspond to the clamping position and the escaping position of the opening/closing piston 27, respectively. By such a structure, when the opening/closing piston 27 moves to the clamping position as shown in FIG. 1, the position detecting sensor 57a is sensitive to the magnetic force of the magnet 56 and detects that the clamp arm 22 has been at the clamping position. Meanwhile, when the opening/closing piston 27 reaches the escaping position, the position detecting sensor 57b is sensitive to the magnetic force of the magnet 56 and detects that the clamp arm 22 has been at the escaping position.

A fastening rod 62 linked to the piston rod 28 enters into a bottomed, receiving hole 61 formed in the lock cylinder 25, wherein the fastening rod 62 constitutes a part of the piston rod 28. A locking piston 64 is accommodated into a cylinder hole 63 formed in the lock cylinder 25 so as to be reciprocable in a radial direction with respect to the piston rod 28, i.e., in a horizontal direction. The locking piston 64 is provided with a locking portion 66 that contacts with a locking face 65 of a concave portion 65a formed in the fastening rod 62. The locking face 65 serves as an inclined face that is inclined by an angle θ with respect to a moving direction of the locking piston 64. An inclined face that contacts with the locking face 65 is formed in the locking portion. This inclination angle θ is set at 45° or less. The cylinder hole 63 is covered with a cover 67 fixed to the lock cylinder 25. In order that a forward-directional spring force orientated to the fastening rod 62 is applied to the locking piston 64, a helical compression spring 68 as a spring member is incorporated between the cover 67 and the locking piston 64. Since the inclination angle θ of the locking face 65 is set to 45° or less, the spring force is increased due to a wedge effect and transmitted as a fastening force to the piston rod 28.

In order that a retreat-directional thrust force is applied to the locking piston 64 against the spring force, a pressurizing chamber 69 formed between the locking piston 64 and the lock cylinder 25 communicates with the supply/discharge port 36a. Accordingly, as show in FIG. 1, while the clamp arm 22 is at the clamping position, when the locking portion 66 of the locking piston 64 contacts with the locking face 65 of the fastening rod 62, even if the fluid in the clamp pressurizing chamber 26b is exhausted therefrom, the clamp arm 22 can be held in a clamping state. Meanwhile, when the clamp arm 22 is driven from the clamping position to the escaping position, if the fluid is supplied from the supply/discharge port 36a, the locking piston 64 moves backward against the spring force due to the thrust force of the fluid supplied into the pressurizing chamber 69, and the locking portion 66 is separated away from the locking face 65. After the separation, the opening/closing piston 27 is driven forward by the fluid flowing into the escaping operation chamber 26a.

Compressed air as the fluid is supplied into each of the pressurizing chamber and the escaping operation chamber described above, a supply source (not shown) of the compressed air is connected via a pipe or pipes to each of the supply/discharge ports, and solenoid valves provided to the pipes are driven by a control signal sent from a controller (not shown), so that the clamp arm 22 is automatically driven at the clamping position and the escaping position. Since signals from the respective magnetic sensors are inputted into the controller, the position of the clamp arm 22 is automatically detected and simultaneously it is automatically detected that the panel material W is positioned by the locating pin 12 and contacts with the contact face 15. A plurality of positioning and clamping apparatuses are arranged on the welding stage for clamping the panel material W and performing a welding operation thereto, and the panel material W as a workpiece is positioned and clamped by the plurality of locating pins 12.

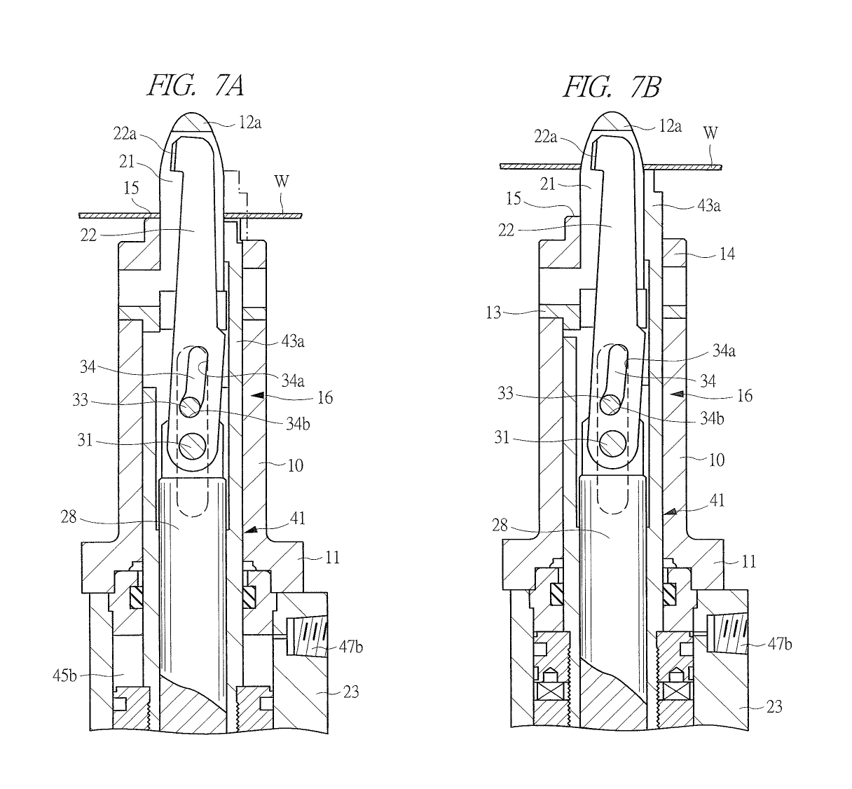

FIGS. 7A and 7B are each a schematic view showing an operation state of the positioning and clamping apparatus described above. FIG. 7A shows a state where the clamp arm 22 has been moved from the clamping position shown in FIG. 1 to the escaping position. Under the condition that the clamp portion 22a of the clamp arm 22 clamps the panel material between the clamp arm 22 and the contact face 15 as shown in FIG. 1, when the fluid is supplied from the supply/discharge port 36a, the locking piston 64 moves backward as described above to release the lock of the piston rod 28 and simultaneously the piston rod 28 moves forward due to the fluid added into the opening/closing piston 27, whereby the clamp arm 22 becomes at the escaping position as shown in FIG. 7A.

Under this state, when the fluid is supplied from the supply/discharge port 47a, the pusher 41 is driven up to the forward limit position shown in FIG. 7B by the pushing piston 44. By such a structure, the panel material W is pushed out up to a small-diameter tip portion of the locating pin 12 and carried to the next process by a carrying device (not shown).

On the other hand, when the panel material W is attached to the locating pin 12 and then positioned and clamped by the locating pin 12, while the clamp arm 22 is at the escaping position as shown in FIG. 7A, the fluid is supplied from the supply/discharge port 47b to move the pushing piston 44 up to the retreat limit position. Thereafter, the fluid in the retreat pressurizing chamber 45b is exhausted from the supply/discharge port 47b. By such a structure, since the pushing piston 44 is moved forward due to the spring force of the helical compression spring 53 until the spring receiving seat 52 contacts with the step portion 50, the pusher 41 becomes at the waiting position.

Under the condition that the pusher 41 has been set at the waiting position, when the locating pin 12 is caused to penetrate through the through-hole of the panel material W in order that the panel material W is set to the locating pin 12, the panel material W pushes down the pusher 41 by the pushing bar members 41a to 41c, whereby the panel material W contacts with the contact face 15. Due to pushing-down movement of the pusher 41, the pushing piston 44 is moved to the retreat limit position shown in FIG. 1 against the spring force of the helical compression spring 53, whereby the position detecting sensor 55a sensitive to the magnetic force of the magnet 54 and detects that the pushing piston 44 has been retreated up to the position shown in FIG. 1.

Under this state, when the fluid is supplied into the clamp pressurizing chamber 26b from the supply/discharge port 36b, the opening/closing piston 27 is driven up to the retreat limit position shown in FIG. 1, whereby the clamp arm 22 comes out from the escaping position to the clamping position so that the panel material W is clamped between the contact face 15 and the clamp portion 22a. When the opening/closing piston 27 moves backward, the fluid in the escaping operation chamber 26a acts on the locking piston 64 so that it serves as a back pressure in a direction of retreating the locking piston 64. Therefore, while the locking piston 64 is moved backward, the piston rod 28 moves backward. After the piston rod 28 moves up to the retreat limit position, the locking piston 64 moves forward due to the spring force of the helical compression spring 68 and enters into the concave portion 65a formed in the fastening rod 62 so that the locking portion 66 of the locking piston 64 contacts with the locking face 65. By such a structure, even when the fluid in the clamp pressurizing chamber 26b is exhausted therefrom, the clamp arm 22 continues clamping the panel material W. Thus, since the lock cylinder 25 is attached to the cylinder body 23, even when the fluid is exhausted from the clamp pressurizing chamber 26b, the clamp arm 22 can be held at the clamping position. Therefore, when the positioning and clamping apparatus is mounted on a carrier truck or robot arm, even if the fluid is exhausted, the panel material W can be carried.

The present invention is not limited to the above-described embodiment and, needless to say, may be variously modified and altered within a scope of not departing from the gist thereof. For example, although the locating pin 12 is provided with one clamp arm 22, the locating pin 12 may be provided with two clamp arms 22 as disclosed in Patent Document 1. In this case, since the clamp arms 22 come out from both sides of the locating pin 12 through the slit 21, the pusher 41 is provided with two pushing bar members that are displaced an angle of 90° from each other with respect to the clamp arms 22. Although the pusher 41 is provided with three pushing bar members 43a to 43c, any one of the pushing bar members 43a to 43c may be provided thereto.

Also, although the clamp arm 22 is fastened at the clamping position by fastening the piston rod 28 to the cylinder body 23, if the clamp arm 22 can be held at the clamping position by the fluid, a rear end portion of the cylinder body 23 may be covered with a head cover instead of using the lock cylinder 25.

The positioning and clamping apparatus can be mounted on not only the welding stage as described above but also a robot arm, a carrier truck, or the like.

What is claimed is:

1. A positioning and clamping apparatus, comprising:
a support cylinder provided with a contact face, with which a panel material contacts, and provided with a locating pin protruding from the contact face and penetrating through a through-hole formed in the panel material;
a cylinder body linked to the support cylinder, and receiving axially reciprocably an opening/closing piston provided with a piston rod;
a clamp arm provided in a slit formed in the locating pin, and linked swingably to the piston rod;
a cam member penetrating through a cam hole formed in the clamp arm to be fixed to the support cylinder, the cam member causing the clamp arm to move, due to forward movement of the opening/closing piston, at an escaping position where the clamp arm is escaped into the slit, and causing the clamp arm to come out, due to retreat movement of the opening/closing piston, at a clamping position where the panel material is clamped between a clamp portion and the contact face;
a pusher protruding from the contact face, and mounted axially reciprocably in the support cylinder between a removal position where the panel material is removed from the locating pin and a retreat limit position where the pusher enters into the contact face; and
a pushing piston linked to the pusher and received reciprocably in the cylinder body, and driving the pusher between the removal position and the retreat limit position.

2. The positioning and clamping apparatus according to claim 1, further comprising:
a spring member causing the pusher to come out at a waiting position which is between the removal position and the retreat limit position; and
a position detecting sensor for detecting a position of the pushing piston,
wherein the position detecting sensor detects that the panel material causes the pusher to move backward against a spring force of the spring member and contacts with the contact face.

3. The positioning and clamping apparatus according to claim 1, further comprising:
a forward pressurizing chamber for supplying fluid which applies a forward-directional thrust force to the pushing piston; and
a retreat pressurizing chamber for supplying fluid which applies a retreat-directional thrust force to the pushing piston,
wherein the forward pressurizing chamber and the retreat pressurizing chamber are formed in the cylinder body.

4. The positioning and clamping apparatus according to claim 1, further comprising:
a clamp pressurizing chamber for applying a retreat-directional thrust force to the opening/closing piston; and
an escaping operation chamber for applying a forward-directional thrust force to the opening/closing piston,
wherein the clamp pressurizing chamber and the escaping operation chamber are formed in the cylinder body.

5. The positioning and clamping apparatus according to claim 4, wherein a spring member for applying the forward-directional thrust force to the opening/closing piston is mounted into the escaping operation chamber.

6. The positioning and clamping apparatus according to claim 4, wherein fluid for applying a forward-directional thrust force to the opening/closing piston is supplied into the escaping operation chamber.

7. The positioning and clamping apparatus according to claim 1, wherein a locking piston, contacting with a locking face formed in the piston rod, is received in a lock cylinder provided to the cylinder body so as to be horizontally reciprocable with respect to the piston rod, a spring member for applying, to the locking piston, a thrust force orientated to the piston rod, is incorporated into the locking cylinder, and the clamp arm is held at the clamping position by contacting the locking piston and the locking face to each other.
